(19) United States
(12) Patent Application Publication
(10) Pub. No.: US 2009/0139606 A1
(43) Pub. Date: Jun. 4, 2009

(54) CONTOURED DOOR WITH SEAL

(75) Inventors: Darron G. Peddle, Millersburg, IN (US); Timothy D. Heiman, Warsaw, IN (US)

Correspondence Address: DON W. BULSON (PARK);RENNER, OTTO, BOISSELLE & SKLAR, LLP, 1621 EUCLID AVENUE / 19TH FLOOR, CLEVELAND, OH, 44115, US

(73) Assignee: Parker-Hannifin Corporation, Cleveland, OH (US)

(21) Appl. No.: 12/325,504

(22) Filed: Dec. 1, 2008

Related U.S. Application Data
(60) Provisional application No. 60/991,234, filed on Nov. 30, 2007.

(51) Int. Cl. B60K 15/05

(52) U.S. Cl. 141/350; 180/313

(57) ABSTRACT

A compact closure assembly for a capless filler tube for a fuel tank includes a housing having a passageway extending therethough for receiving a fuel filler nozzle, and a door moveable from a first position sealing the passageway to a second position permitting insertion of the fuel filler nozzle into the passageway. The door is contoured such that when in the second position, the outer surface of the door is generally concentric with a wall of the housing about a longitudinal axis of the passageway. Accordingly, much of the additional space found in conventional closure assemblies that is needed for accommodating the flat door in the open position can be eliminated.

### RELATED APPLICATIONS

This application claims the benefit of U.S. Provisional Application No. 60/991,234 filed Nov. 30, 2007, which is hereby incorporated herein by reference.

### FIELD OF THE INVENTION

The present invention relates generally to automotive refueling systems and, more particularly, to a door for sealing a fuel tank filler tube.

### BACKGROUND OF THE INVENTION

Motor vehicles are typically provided with a hinged fuel filler access panel on the outer surface of the vehicle for accessing a fuel tank filler neck located in a cavity enclosed by the panel. The fuel tank filler neck is typically capped with a suitable cap that is usually screwed onto threads surrounding the fuel tank filler neck to provide a tight seal. In such arrangements, the cap is generally relied upon for sealing the filler neck to prevent escape of fuel vapors to the atmosphere.

Most fuel filler necks are also fitted with an aperture sized to receive a specific nozzle for a certain type of fuel, and a non-sealing trap door for closing the aperture. The trap door is typically a spring biased flapper door that can be pushed open upon insertion of the dispensing nozzle, and automatically closes upon removal of the dispensing nozzle.

Such arrangements utilizing caps can be troublesome under some circumstances. For example, if after removal of the cap for refueling the user does not reinstall the cap properly and/or tightly, fuel vapors can escape to the atmosphere. Further, a user may fail to reinstall the cap at all and misplace the cap, thus requiring the purchase of a replacement cap.

A recent trend in the industry has been towards smaller, more compact filler openings, and efforts have been made to eliminate the fuel cap used to seal the fuel filler neck and to rely on the spring biased flapper door for automatically sealing the filler tube when the refueling operation has been completed and the nozzle withdrawn from the filler tube. In such designs, the flapper door is typically provided with a suitable seal for sealing against a corresponding surface of the fuel filler neck or other surface.

### SUMMARY OF THE INVENTION

The present invention provides a compact closure assembly for a capless filler tube for a fuel tank that eliminates much of the additional space found in conventional closure assemblies needed for accommodating the door in the open position.

Accordingly, a compact closure assembly for a capless filler tube for a fuel tank comprises a housing having a passageway extending therethough for receiving a fuel filler nozzle, and a door moveable from a first position sealing the passageway to a second position permitting insertion of the fuel filler nozzle into the passageway. The door is contoured such that when in the second position, the outer surface of the door is generally concentric with a concave inner surface of the housing about a longitudinal axis of the passageway.

More particularly, the inner surface of the housing can be generally cylindrical, and the housing can be configured to be telescoped over an end of a filler tube. The radially outer surface of the door can be generally cylindrical. The door can be contoured such that when in the second position, the inner surface of the door is generally concave for nesting with a convex surface of a nozzle. The door, when in the second position, can be spaced apart from the wall of the housing, and the end of the filler tube can be located between the housing wall and the door when the door is in the second position.

A seal element for sealing the door to the housing when in the first position can be provided on the door or the housing. The contour of the door can be generally saddle-shape, for example, and can be hingedly attached to the housing at one edge for pivoting movement between the first and second positions.

According to another aspect, a vehicle comprises a fuel tank having a filler tube and the closure assembly secured to the filler tube.

Further features of the invention will become apparent from the following detailed description when considered in conjunction with the drawings.

### BRIEF DESCRIPTION OF THE DRAWINGS

FIG. 1 a schematic view of an exemplary vehicle having a fuel tank with a capless filler tube and closure assembly in accordance with the invention.

FIG. 2 is a cross-sectional view of an exemplary closure assembly for a capless filler tube for a fuel tank in a closed position in accordance with the invention.

FIG. 3 is a cross-sectional view of the closure assembly of FIG. 2 in an open position.

FIG. 4 is a bottom view of the closure assembly of FIG. 2 in the open position.

FIG. 5 is a cut-away view of the closure assembly of FIG. 2 having a filler nozzle inserted therein.

FIG. 6 is a bottom view of the closure assembly of FIG. 1 illustrating the packaging space savings as compared to a conventional closure assembly.

### DETAILED DESCRIPTION

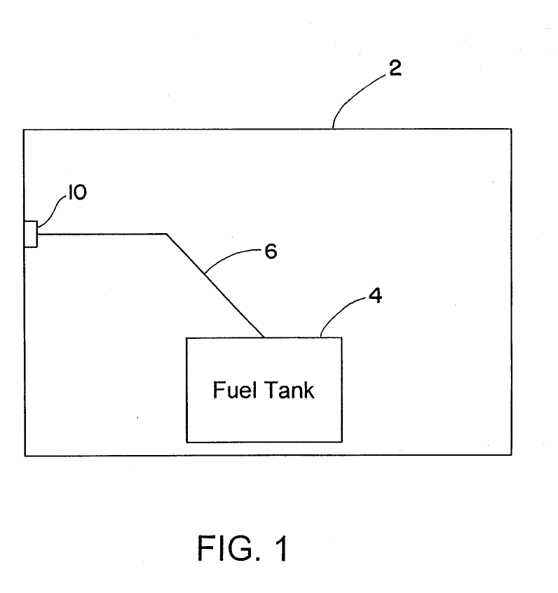

Referring now to the drawings in detail, and initially to FIG. 1, an exemplary vehicle 2 is illustrated including a fuel tank 4, a capless filler tube 6, and an exemplary closure assembly 10. The closure assembly 10 is installed on the end of the fuel filler tube 6 for sealing the fuel filler tube 6 against the escape of liquid and/or vapors from the tank 4, while permitting insertion of a nozzle for dispensing fuel into the fuel tank, as will be described below.

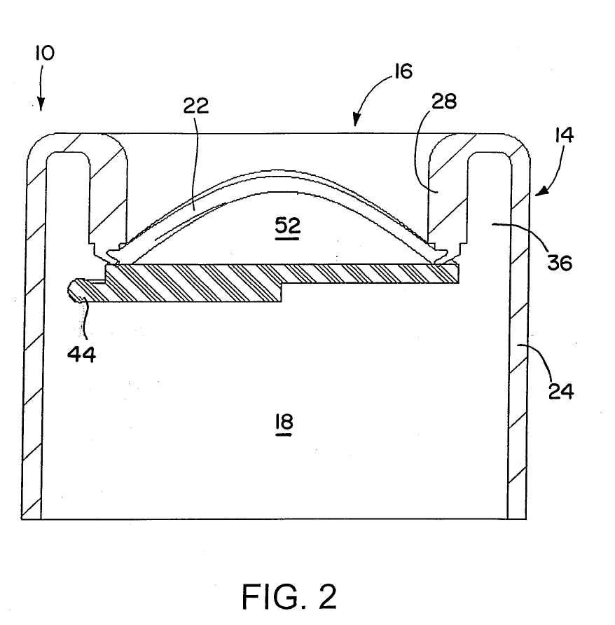

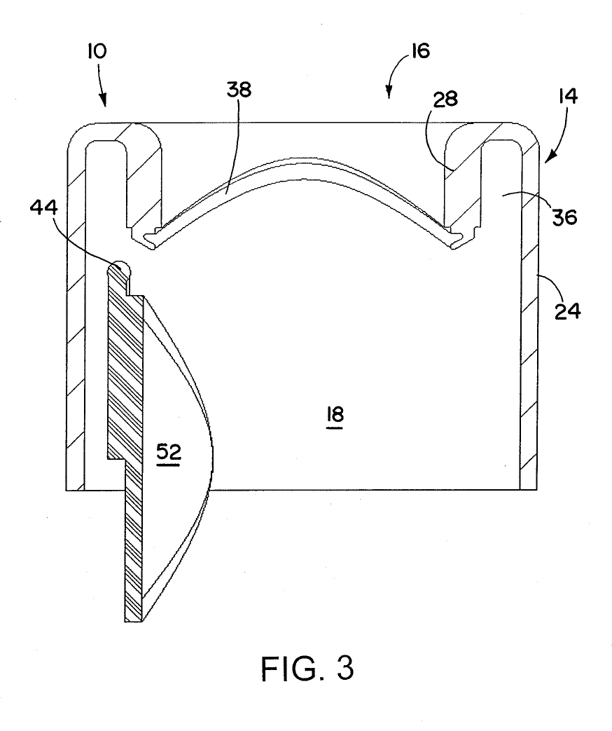

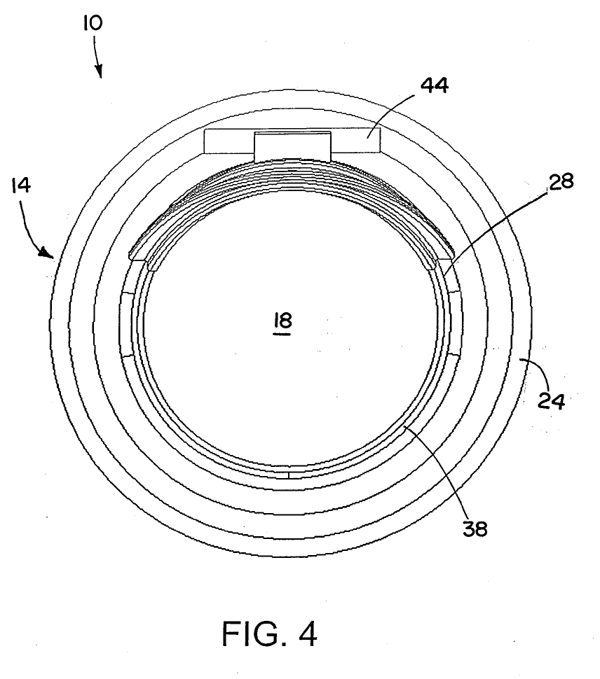

Turning to FIG. 2, the closure assembly 10 includes a generally cylindrical housing 14 having a cylindrical opening 16 leading to a passageway 18 extending therethrough. A contoured door 22 is supported by the housing 14, for example by a hinge, for pivoting movement between a first closed position shown in FIG. 2, and a second open position shown in FIGS. 3 and 4.

The cylindrical housing 14 has a cylindrical outer wall portion 24, and a cylindrical inner wall portion 28. The inner wall portion 28 generally forms the opening 16 of the passageway 18 into which a filler nozzle can be inserted. The inner wall portion 28 is radially spaced-apart from the outer wall portion 24 thereby creating an annular space 36 for receiving an end portion of the filler tube when installed thereon. This annular space 36 permits the closure assembly 10 to be telescoped over the end of the filler tube 6 and secured thereto in any suitable manner, such as by friction fit, adhesives, or welding, for example.

The inner wall portion 28 includes a contoured sealing surface 38, best seen in FIG. 3. The contoured sealing surface 38 is best described as being saddle shape when viewed along an axis perpendicular to the longitudinal axis of the passageway 18 (as in FIG. 3), and generally cylindrical when viewed along the longitudinal axis of the passageway 18 (see FIG. 4). The sealing surface 36 corresponds to the shape of the contoured door 22 such that, when the contoured door 22 door is in the closed position, the passageway 18 is sealed so as to prevent leakage of vapors from the tank.

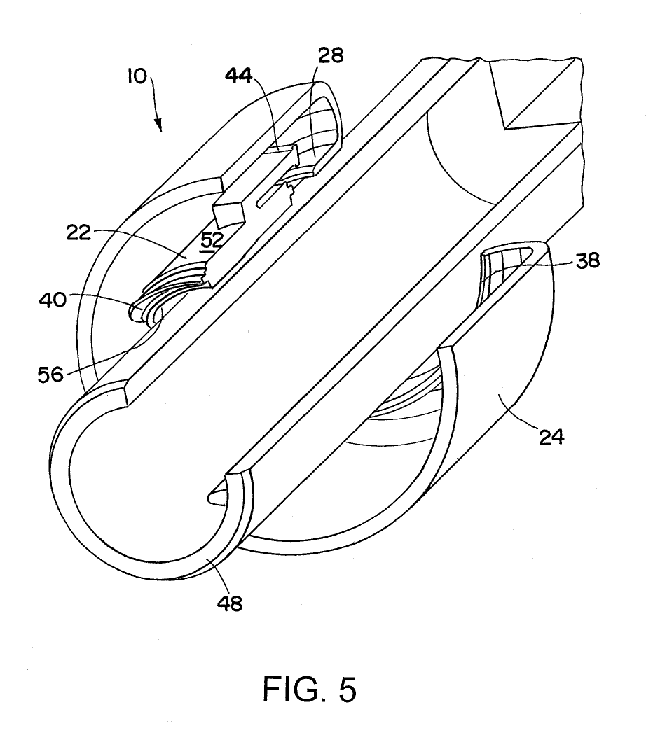

As mentioned, the contoured door 22 is generally saddle shape, and includes a sealing element 40 (see FIG. 5) for sealing the contoured door 22 to the sealing surface 38. The sealing element 40 can be an elastomeric sealing element, for example, or can be any other suitable type of sealing element. Although shown as part of the contoured door 22, the sealing element 40 can alternatively be provided on the contoured sealing surface 38 of the housing 14.

In the illustrated embodiment, the contoured door 22 is attached to the housing 14 via a pivot pin 44 that is secured at respective ends to the housing 14. A biasing element (not shown), such as a torsion spring for example, can be provided for biasing the contoured door 22 towards the closed position such that the contoured door 22 will be normally closed until a nozzle is inserted into the passageway 18 to push the contoured door 22 open.

Turning to FIG. 5, a nozzle 48 is shown inserted into the closure assembly 10, with the contoured door 22 pivoted to the open position. Due to the contoured shape of the door 22, when pivoted to the open position, an outer surface 52 of the door 22 is generally concentric with an inner surface of the outer wall 24 of the housing 14 and/or outer circumferential surface of the nozzle 48 about the longitudinal axis of the passageway 18. In the illustrated embodiment, the outer surface 52 is generally cylindrical and nests with the cylindrical inner surface of the outer wall. It will be appreciated, however, that the outer surface 52 can be convex having other shapes besides cylindrical (e.g., beveled etc.) while still being concentric. Moreover, the outer surface 52 need not be identical in shape to the inner surface of the outer wall 24, but generally only convex to allow the door to “nest” within the concave cylindrical inner surface of the outer wall to conserve space. An inner surface 56 of the contoured door 22 generally cradles (e.g., nests) the outer circumferential surface of the nozzle 48. Thus, it will be appreciated that the contoured door 22, when in the open position, takes up less space than a similar door having a flat outer surface would.

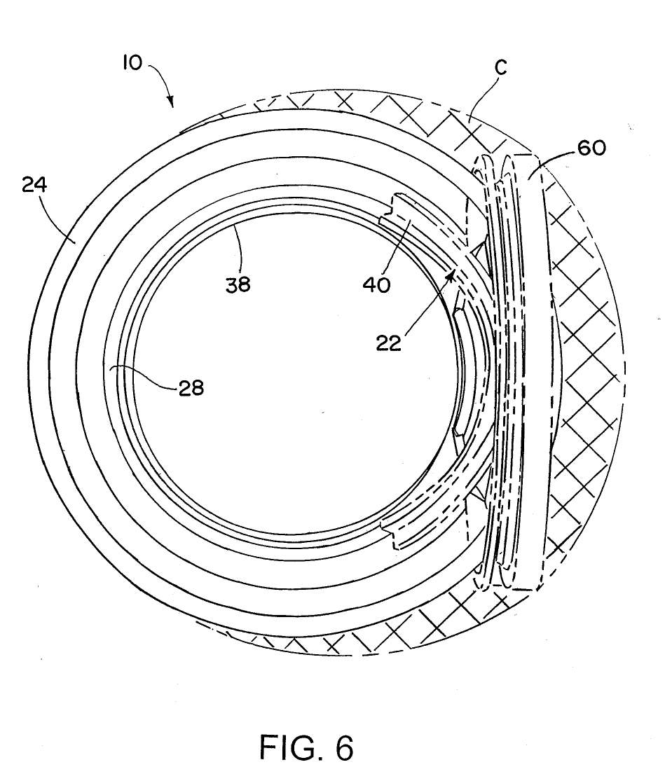

To illustrate the space savings gained by the contoured door 22, in FIG. 6, a conventional flat door 60 is shown in phantom superimposed over the closure assembly 10. As will be appreciated, to accommodate the conventional flat door 60 in the open position, the housing 14 would have to be larger in diameter. The cross-hatched region C illustrates the approximate space savings achieved by the contoured door 22 as compared to the conventional flat door.

Although shown and described in the context of an automotive fuel filler assembly, it will be appreciated that the assembly can be used in a variety of applications. Typical prior art assemblies included seals that are usually overmolded or assembled to the door or housing for forming a seal between the door and housing. The typical prior art sealing surface is flat, although there may be contours on the door that perform functions other than sealing. The sealing surface in accordance with the invention is non-flat. This invention maintains sealing integrity while allowing the door to be configured to minimize space usage when opened.

As will now be appreciated, by configuring the door bottom to fit concentrically inside the diameter of the filler housing when open, the minimum amount of space is consumed. When closed, the curved door mates against a matching curved surface formed on the sealing face of the housing. This concept will function whether the seal is attached to the door or to the housing.

The housing and/or door can be made of any suitable material, such as plastic or metal, for example. The seal may be a fluorocarbon rubber seal for resisting hydrocarbon permeation, but of course can be any suitable material based on a particular application.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A compact closure assembly for a capless filler tube for a fuel tank, comprising a housing having a passageway extending therethough for receiving a fuel filler nozzle, and a door moveable from a first position sealing the passageway to a second position permitting insertion of the fuel filler nozzle into the passageway, wherein the door is contoured such that when in the second position, a radially outer surface of the door is concentric with a concave inner surface of the housing surrounding the passageway about a longitudinal axis of the passageway.

2. A compact closure assembly as set forth in claim 1, wherein the inner surface of the housing is generally cylindrical, and the housing is configured to be telescoped over an end of a filler tube.

3. A compact closure assembly as set forth in claim 1, wherein the radially outer surface of the door is generally cylindrical.

4. A compact closure assembly as set forth in claim 1, wherein the door is contoured such that when in the second position, the inner surface of the door is generally concave and for nesting with a convex surface of a nozzle.

5. A compact closure assembly as set forth in claim 1, wherein the door, when in the second position, is spaced apart from the inner surface of the housing.

6. A compact closure assembly as set forth in claim 1, wherein the assembly further comprises a seal element for sealing the door to the housing when in the first position.

7. A compact closure assembly as set forth in claim 6, wherein the seal is generally annular.

8. A compact closure assembly as set forth in claim 6, wherein the seal is formed of an elastomeric polymeric material.

9. A compact closure assembly as set forth in claim 1, wherein the contour of the door is generally saddle-shape.

10. A compact closure assembly as set forth in claim 1, wherein the door is hingedly attached to the housing at one edge for pivoting movement between the first and second positions.

11. A vehicle comprising a fuel tank having a filler tube and the closure assembly of claim 1 secured to the filler tube.

12. A compact closure assembly for a capless filler tube for a fuel tank, the filler tube having an end with an opening for filling the tank, and the assembly comprising:
a generally cylindrical housing disposed over the filler tube end opening, the housing having an interior and a generally annular inner surface within the interior which defines a housing sealing face about the filler tube end opening, the housing sealing face having non-planar surface contour;
a door positioned within the interior of the housing, the door being moveable within the interior of the housing from a first position closing the filler tube end opening to second position opening the filler tube end opening, the door having a door sealing face which confronts the housing sealing face in the first position of the door, the door sealing face having a non-planar surface contour complementary to the contour of the housing sealing face; and
a seal mounted to one of the housing or door sealing faces, the seal being compressible between the housing and door sealing faces in the first position of the door to effect a fluid-tight seal therebetween.

13. A closure assembly as set forth in claim 12, wherein each of the surface contour of the housing and door sealing faces is generally saddle-shaped.

14. A closure assembly as set forth in claim 12, wherein the seal is generally annular.

15. A closure assembly as set forth in claim 12, wherein the seal is formed of an elastomeric polymeric material.

16. A closure assembly as set forth in claim 12, wherein the door is pivotally mounted within the interior of the housing.
